(19) United States
(12) Patent Application Publication
(10) Pub. No.: US 2008/0112083 A1
(43) Pub. Date: May 15, 2008

(54) Item pivotally connected to a support

(76) Inventor: Sik Leung Chan, Tsuen Wan (HK)

Correspondence Address: Daniel P. Burke, Esq.;DANIEL P. BURKE & ASSOCIATES, PLLC, Suite 131, 300 Rabro Drive, Hauppauge, NY, 11788, US

(21) Appl. No.: 12/008,805

(22) Filed: Jan. 14, 2008

Related U.S. Application Data
(63) Continuation-in-part of application No. 29/267,718, filed on Oct. 18, 2006, now Pat. No. D564024.

(51) Int. Cl. B43K 23/02

(52) U.S. Cl. 360/137

(57) ABSTRACT

An implement, comprising a working portion which can be selectively exposed for use or covered when not in use, is pivotally connected to a support. Upon actuation of a release, the implement automatically moves from a first configuration wherein the working end is disposed at least partially within a support, to a second configuration wherein the working end is exposed. The support and the working portion are pivotally connected via at least one linking arm. Upon the selective actuation of a release, the writing portion rotates from a first configuration to a second configuration. The movement is preferably spring-biased and damped. The support may also include a pocket clip. The pocket clip may be of appropriate size to allow printing of a logo or any other desired indicia. Items include writing implements, and various other usable implements, such as a flashlight, a toothbrush or a laser pen.

### RELATED APPLICATION DATA

This application is a continuation-in-part of U.S. design application Ser. No. 29/267,718 filed Oct. 18, 2006.

The present invention is directed to items, such as writing implements, comprising a working portion disposed at least partially within a support in a closed configuration and which, upon actuation of a release, the working portion pivots to an open configuration, e.g. a working/writing position.

### BACKGROUND

Various writing implements are known wherein it is desirable for functional and/or aesthetic reasons to provide a covering for a writing tip of the writing implement. For example, it is not uncommon for the writing tip to be covered for protection of the writing tip or for protection of a user's article of clothing when carrying the writing implement. Other writing implements have been disclosed wherein manual manipulation moves a tip of a writing implement to a position where it is uncovered by a support.

### SUMMARY OF THE INVENTION

Various embodiments of the present invention are directed to implements comprising a working portion which can be selectively exposed for use or covered when not in use. The illustrated embodiment of the present invention is directed to a writing implement wherein the writing portion is pivotally connected to a support. Upon actuation of a release, the writing implement automatically moves from a first configuration wherein the writing tip is disposed at least partially within a support, to a second configuration wherein the writing tip is exposed. The support and the writing portion are pivotally connected via linking arms. Thus, upon the selective actuation of a release, the writing portion rotates from the first configuration, i.e., the closed position, to the second configuration, i.e., the writing position.

The illustrated embodiment utilizes a biasing mechanism located proximate an intermediate region of the writing portion, which is spring biased to urge the writing portion towards the second configuration. This embodiment further encompasses a damping mechanism for damping the movement of the writing portion and, consequently, slowing the relative movement of the writing portion. This damping is effected by closely spaced surfaces and damping grease.

In one embodiment, the support may be circular in shape; however, it is not limited to this configuration and can be formed in other different configurations, such as rectangular, triangular, oval, etc. The support may also include a pocket clip. The pocket clip may be of appropriate size to allow printing of a logo or any other desired indicia.

The writing portion of the present invention can be replaced with various other usable implements, such as a flashlight, a toothbrush or a laser pen, all of which would function similarly to the illustrated embodiment.

### BRIEF DESCRIPTION OF THE DRAWINGS

FIG. 1 is a top, perspective view of one embodiment of the present invention in the closed position.

FIG. 2 is a bottom, perspective view of the writing implement of FIG. 1.

FIG. 3 is a bottom/front, perspective view of the writing implement of FIG. 1, in the working position.

FIG. 4 is a rear elevation view of the writing implement of FIG. 1 in the closed position.

FIG. 5 is a front elevation view of the writing implement of FIG. 1 in the closed position.

FIG. 6 is a left, side elevational view of the writing implement of FIG. 1.

FIG. 7 is a right, side elevational view of the writing implement of FIG. 1.

FIG. 8 is a bottom end view of the writing implement of FIG. 1.

FIG. 9 is a top end view of the writing implement of FIG. 1.

FIG. 10 is an exploded view of the embodiment of FIG. 1.

### DETAILED DESCRIPTION

Embodiments of the present invention are directed to implements comprising at least one working portion pivotally connected to a support by at least one linking arm. The implements of the present invention are provided with a biasing mechanism which, upon the activation of a release, causes the working portion to rotate from a first configuration wherein the working end is disposed at least partially within the support, to a second configuration wherein the working end is exposed for use.

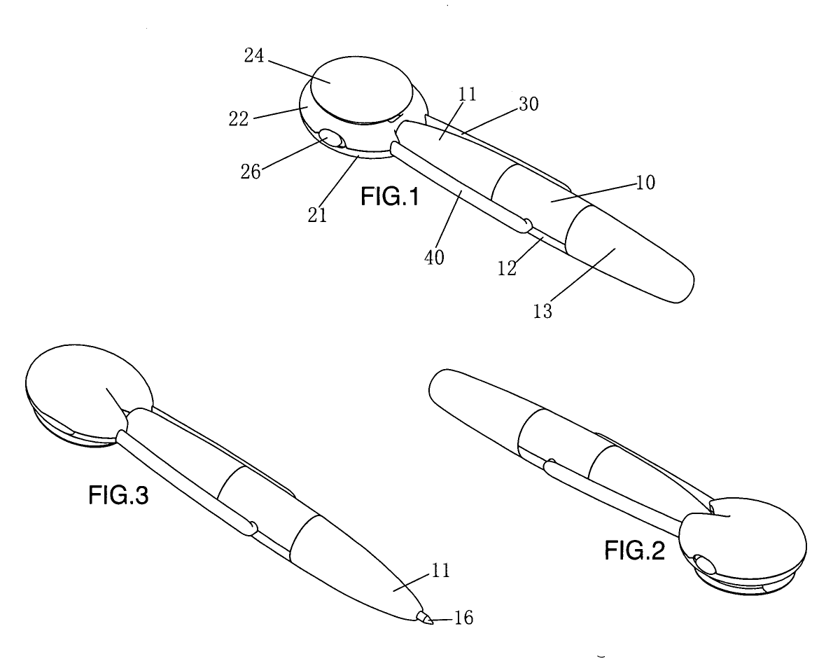

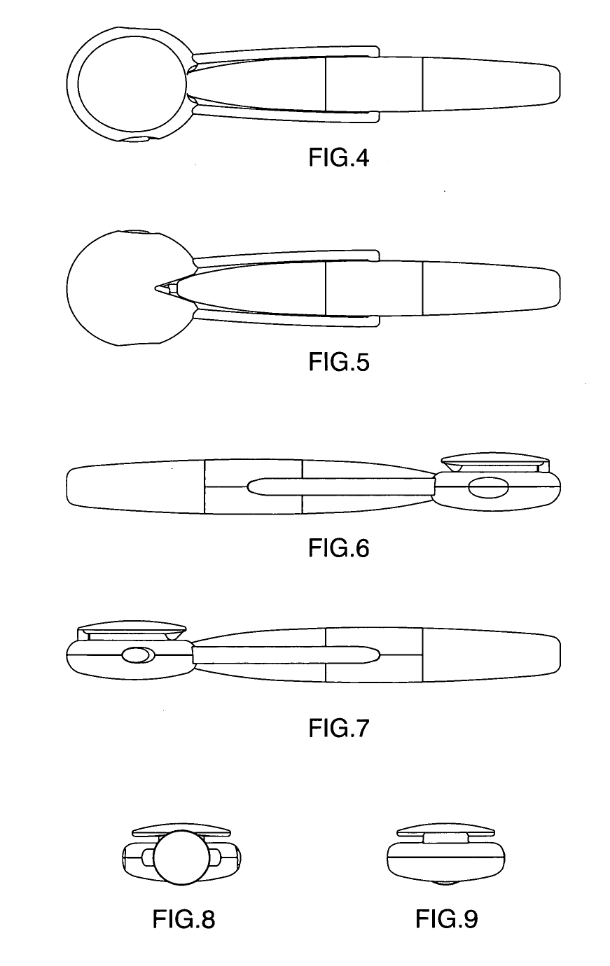

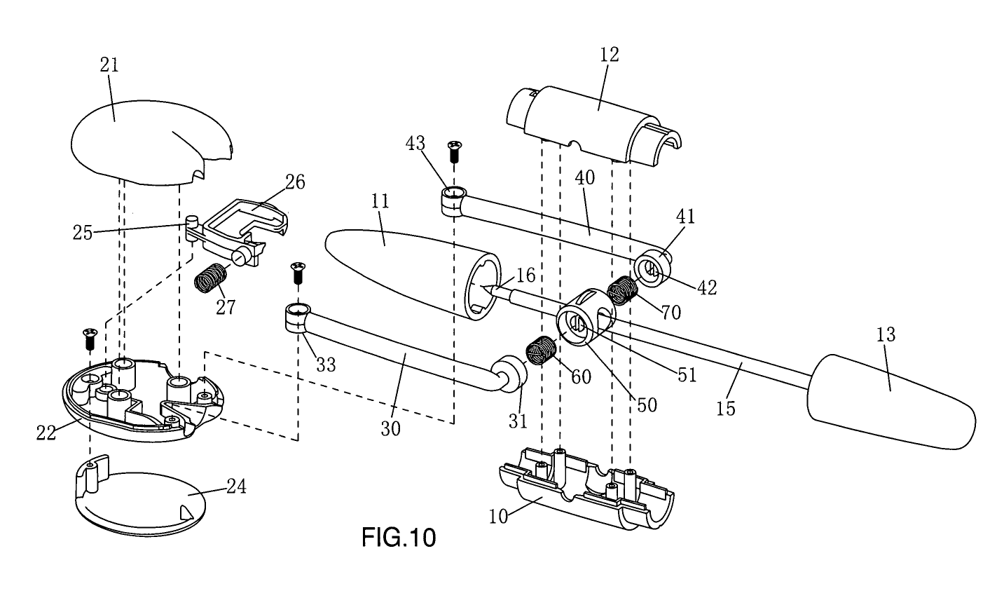

FIGS. 1 through 10 illustrate one embodiment of the present invention in the form of a writing implement, e.g. a pen, with two linking arms. FIGS. 1 thorough 9 are external views and FIG. 10 is an exploded view of this embodiment.

Referring to the embodiment illustrated in FIGS. 1 to 10, a body portion 10 of the writing implement is pivotally connected to a support 20 via two linking arms 30, 40. The support 20 provides a convenient gripping portion for a user and also shields the writing tip when not in use. The linking arms 30, 40 are pivotally connected proximate an intermediate portion of the body portion 10. The body portion 10 is in a closed position in FIG. 1.

The body portion 10 comprises a writing tip portion 11, and intermediate portion 12, and a remote portion 13. The intermediate region 13 of the writing portion may include the center of the body portion 10 relative to the writing tip portion 11 and the remote portion 12, as well as any region up to about 25% on either side of the center of the body portion. A useable writing implement such as a pen refill 15 is supported partially within the body portion. The writing tip portion 11 and the remote portion 13 can be permanently attached to the intermediate portion 12 or may be removably connected thereto. For example, these portions can be removably connected with threaded portions, bayonet-type connections, or in other manners known in the art.

Intermediate portion 12 of the illustrated body portion 10 houses a drive mechanism which normally urges body portion 10 to the working position. The driving mechanism of this embodiment comprises a damping cylinder 50, two coil springs 60 and 70 and two damping drums 31 and 32. The damping cylinder 50 is fixed relative to the body portion 10. In this embodiment, the damping cylinder 50 is mounted on the refill 15 which does not move relative to the body portion 10.

Each spring 60 and 70 advantageously comprises crosswires extending radially at each end thereof. An internal end 61 of spring 60 engages a slot 51 in damping cylinder 50. Therefore, internal end 61 of spring 60 does not rotate with respect to the body portion 10. An external end 62 of spring 60 similarly engages a slot 32 within damping drum 30. Coil spring 70 on the opposite side is arranged similarly. An internal end 71 of spring 70 engages a slot 52 in damping cylinder 50. An external end 72 of spring 70 similarly engages' a slot 42 within damping drum 40. The coil springs 60 and 70 are advantageously pre-wound to provide a desired torsional force. Therefore, the coil springs 60 and 70 will normally urge body portion 10 from the closed position (FIG. 1) to the working position (FIG. 3).

Damping drums 31 and 41 are generally cylindrical in shape and, in this illustrated embodiment, damping drums 31 and 41 are integrally formed on linking arms 30 and 40, respectively. Damping drums 31 and 41 are arranged concentrically to and, at least partially within, opposite sides of damping cylinder 50. A damping grease such as highly viscous oil or grease is disposed between the outer surfaces of damping drums 31 and 41 and the inner surfaces of damping cylinder 50. The damping cylinder 50 and damping drums 31 and 41 are relatively rotatable to each other under the urging of coil springs 60 and 70. The arrangement of damping grease between the outer surface of damping drums 31 and 41 and the damping cylinder 50 dampens the relative pivotal movement of body portion 10.

While the above discloses the damping drums 31 and 41 of the illustrated embodiment are at least partially arranged in the damping cylinder 50, it is within the scope of the present invention for the damping cylinder 50 to have the smaller circumference and be at least partially arranged within the damping drums 31 and 41. If damping cylinder 50 has a smaller circumference relative to damping drums 31 and 41, the damping grease is disposed between the outer surface the damping cylinder 50 and the inner surfaces of the damping drums 31 and 41. Other driving mechanisms are also within the scope of the present invention provided that they provide the desired driving force and a damped motion.

Linking arms 30 and 40 pivotally connect support 20 to body portion 10. Linking arms 30 and 40 comprise proximal ends 33 and 43, which are fixedly connected to support 20, and damping drums 31 and 41 on the distal ends thereof. While the illustrated embodiment comprises two linking arms, it is within the scope of the present invention to use one linking arm or a greater number of linking arms.

The support 20 comprises a front portion 21 and a back portion 22. Support 20 securely engages proximal ends 33 and 34 of linking arms 30 and 40. Support 20 also supports a release mechanism which permits the selective release of the body portion 10. Support 20 further comprises an opening 23. The illustrated support also comprises a pocket clip 24 mounted thereon. The support of the present embodiment is generally circular in shape and includes a triangular recess for receiving the writing tip end. Alternatively, the support and the recess may have other configurations.

The release mechanism of the illustrated embodiment is shown in FIG. 10. In the illustrated embodiment, the release mechanism comprises a spring-biased latch bracket 25 pivotally connected to the support 20. A release button 26 is accessible to a user. The spring biasing is provided by a coil spring 27. In the closed configuration shown in FIG. 1, the release button 26 is biased outwardly through opening 23 of the support 20 by coil spring 27. Until the release button 26 is depressed, the latch bracket 25 engages the writing tip 16 to prevent unintended opening of the body portion. Other types of release mechanisms can be used. Alternatively, the release mechanism may comprise a coil spring.

When release button 26 is depressed, the latch bracket 25 moves and releases the writing tip portion 11 thereby allowing pivotal movement of the body portion 10. During this pivotal movement, the body portion moves about an axis perpendicular to the longitudinal axis of the support. The body portion 10 pivots approximately 180° from the closed position to the working position wherein the writing tip 16 is exposed for use.

While the illustrated embodiment is a pen, the advantages of the present invention can be used with other writing implements such as pencils and felt markers, as well as other items such as flashlights, toothbrushes, and laser pens.

1. A writing implement comprising:
a body portion comprising a writing tip portion, a remote portion opposite said writing tip portion and an intermediate portion between said writing tip portion and said remote portion;
a support;
at least one linking arm pivotally connecting said body portion with said support, said at least one linking arm comprising a proximal end and a distal end;
said proximal end of said at least one linking arm being connected to said support, and said distal end of said at least one linking arm being pivotally connected to said intermediate portion of said body portion;
means for selectively biasing said body portion from a first configuration to a second configuration.

2. A writing implement according to claim 1 wherein, in said first configuration, said support engages and retains said writing tip portion.

3. A writing implement according to claim 1 further comprising means for releasably engaging said writing tip portion.

4. A writing implement according to claim 3 wherein said engaging means is for selective releasable engagement and locking retention of said support proximate said writing tip portion.

5. A writing implement according to claim 3 wherein said engaging means is manually releasable.

6. A writing implement according to claim 3 wherein said engaging means comprises a spring biased latch.

7. A writing implement according to claim 6 wherein said spring biased latch is positioned at least partially within said support.

8. A writing implement according to claim 6 wherein said support comprises an opening, and wherein said spring biased latch partially extends through said opening.

9. A writing implement according to claim 8 wherein said spring biased latch further comprises a button, and wherein said button partially extends through said opening.

10. A writing implement according to claim 3 wherein said engaging means is positioned at least partially within said support.

11. A writing implement according to claim 1 wherein said support comprises a printable surface.

12. A writing implement according to claim 11 wherein said printable surface is about 6 to about 10 square centimeters.

13. A writing implement according to claim 1 further comprising a pocket clip.

14. A writing implement according to claim 13 wherein said pocket clip comprises a printable surface of about 6 to about 10 square centimeters.

15. A writing implement according to claim 1 wherein said means for selectively biasing comprises at least one spring.

16. A writing implement according to claim 15 wherein said at least one spring is connected to said at least one linking arm.

17. A writing implement according to claim 15 wherein said at least one spring urges said body portion toward said second configuration.

18. A writing implement according to claim 1 wherein said biasing means is arranged proximate said intermediate portion.

19. A writing implement according to claim 1 further comprising means for damping movement of said body portion from said first configuration to said second configuration.

20. A writing implement according to claim 19 wherein said damping means comprises at least two relatively movable, spaced surfaces with a viscous grease disposed between said surfaces.

21. A writing implement according to claim 19 wherein said damping means comprises at least two, relatively movable, substantially cylindrical surfaces with a viscous grease disposed between said surfaces.

22. A writing implement according to claim 19 wherein said damping means is positioned proximate said intermediate portion.

23. A writing implement according to claim 19 wherein said damping means comprising a first damping drum in close proximity with a second damping drum, a viscous grease and a damping cylinder, wherein said first and second damping drums and said viscous grease are positioned proximate said damping cylinder.

24. A writing implement according to claim 23 wherein said first damping drum is formed on said at least one linking arm.

25. A writing implement according to claim 23 wherein said second damping drum is formed on a second linking arm.

26. A writing implement according to claim 23 wherein said damping cylinder is positioned proximate said intermediate portion, said first and second damping drums arranged at least partially within said damping cylinder.

27. A writing implement according to claim 1 wherein said support has a longitudinal axis and said body portion rotates approximately 180° about an axis perpendicular to said longitudinal axis.

28. A writing implement according to claim 1 wherein said body portion comprises a ball point pen.

29. A writing implement according to claim 1 wherein said body portion comprises at least partially separable sections.

30. A usable implement comprising:
a body portion comprising an operative portion, a remote portion opposite said operative portion and an intermediate portion between said operative portion and said remote portion;
a support;
at least one linking arm pivotally connecting said body portion with said support, said at least one linking arm comprising a proximal end and a distal end;
said proximal end of said at least one linking arm connected to said support, and said distal end of said at least one linking arm pivotally connected to said intermediate portion of said body portion;
means for selectively biasing said body portion from a first configuration to a second configuration.

31. A useable implement according to claim 30 wherein said body portion comprises a toothbrush.

32. A usable implement according to claim 30 wherein said body portion comprises a flashlight.

33. A usable implement according to claim 30 wherein said body portion comprises a writing implement.

34. A usable implement according to claim 30 wherein said body portion comprises a pen.
